(19) United States
(12) Patent Application Publication
(10) Pub. No.: US 2010/0198674 A1
(43) Pub. Date: Aug. 5, 2010

(54) Brand Experience System

(76) Inventor: John Boucard, Pasadena, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/364,860

(22) Filed: Feb. 3, 2009

(51) Int. Cl. G06Q 30/00

(52) U.S. Cl. 705/14.25; 705/14.66

(57) ABSTRACT

A brand experience system includes a management server that receives data captured by a capture device over a network. The data received by the management server includes a locator ID identifying a location at which the data is captured and a user ID identifying a user account associated with the user of the capture device. The management server looks up matching services, such as a brand experience service, social networking service, or other third party services, using the user ID and the locator ID. Additional information, such as product data, date and time of data capture, in the received data can also be used for determining the matching services. The management server provides the user with links to the matching services and advertisements relating to the matching services. The management server also forwards the received data to the matching services to update user accounts.

### FIELD OF THE INVENTION

The embodiments of the present invention relate to the management and sharing of data captured by a portable capture device. Specifically, the embodiments of the invention relate to the management and sharing of captured brand data through a management server that is coupled to other web servers.

### BACKGROUND OF THE INVENTION

Loyalty programs are marketing programs utilized by companies and advertising firms to improve sales for the associated company. The loyalty program award points to customers through codes printed on products produced by the company. The user must then access a website provided by the company and input these codes to be credited to an account that the user creates on that specific website. However, this system rewards a user only when a user purchases a product and enters purchase data on the company's loyalty program website. It is difficult to entice a user to frequently check out the loyalty program website for advertisements and promotions when a purchase in a store did not occur. As a result, a company cannot fully rely on its loyalty program to increase its website traffic and to promote new products.

Social networking sites also suffer from similar problems relating to convenience and access for users. Social networking websites provide tools for interacting with friends and business contacts to share information, media and contacts. These resources are sharable through linking accounts in the social networking website and by correspondence via electronic mail. However, in real world social settings these tools are not easily accessible or convenient. Even with the availability of mobile and handheld wireless devices, the process of sharing information and experiences is impractical and time consuming. For example, the process may involve multiple steps including logging into the site, entering the places that a user has visited and things that the user has done, and copying website links to the user's web page for sharing with friends. As a result, the services of the social networking site cannot be relied upon and many potential networking opportunities are lost. Overtime the use of the social networking site is reduced due to these impracticalities.

### SUMMARY

The embodiments of the invention include a capture device for capturing brand data and a system for managing the captured data for the user of the capture device. The system includes a management server that manages data transfer between the capture device and other web services. The management server receives data captured by the capture device over a network. The data received by the management server includes a locator ID identifying a location at which the data is captured and a user ID identifying a user account associated with the user of the capture device. The management server looks up matching services, such as a brand experience service, social networking service, or other third party services, using the user ID and the locator ID. Additional information, such as product data and date and time of data capture, in the received data can also be used for determining matching services. The management server provides the user with links to the matching services and advertisements relating to the matching services. The management server also forwards the received data to the matching services to update user accounts with those services.

The brand experience system can be used to track a user's habits and actions. The system includes a brand experience server to maintain a user account under a brand loyalty program. The brand experience server provides information or interactive features relating to the user account by displaying new points added to the account, rewards available to the account, and a map showing the nearest retail locations to the user where products of the brand can be purchased. The system also includes third party servers, which provide web services to a user including services that enable the user to share captured data with his friends using plug-ins such as widgets. A widget can be embedded in a user's web page to supplement or expand the features of a social networking website. For example, a widget may use the locator IDs as widget data to display a map of the geographical locations of the retailers that a user has visited.

### BRIEF DESCRIPTION OF THE DRAWINGS

Embodiments are illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

FIG. 1 is a block diagram of one embodiment of a networked system for managing and sharing data captured by a user's capture device.

FIG. 2 is a diagram of one embodiment of an environment in which brand data is captured.

FIG.3 is a diagram of one embodiment of a data exchange process for transferring the brand data to a management server and receiving information from the management server.

FIG. 4 is a diagram of one embodiment of a capture device for capturing the brand data.

### DETAILED DESCRIPTION

In one embodiment, the brand experience system includes a management server that receives data captured by a capture device over a network. The data received by the management includes a locator ID identifying a location at which the data is captured and a user ID identifying a user account associated with the user of the capture device. The management server looks up matching services, such as a brand experience service, social networking service, or other third party services, using the user ID and the locator ID. Additional information, such as product data, date and time of data capture, and the like, in the received data may also be used for determining the matching services. The management server provides the user with links to the matching services and advertisements relating to the matching services. The management server also forwards the received data to the matching services to update user accounts.

The brand experience system manages data captured by a user's capture device to track the user's habits and actions. The captured data is referred to as brand data, which includes a locator ID and some or all of product data, date and time, and other miscellaneous data. The locator ID may be used to identify location information such as a retailer, a store location of the retailer, and a shelf location within a store. The management server can send the brand data to a widget for execution by a third party server to display user actions on the third party website. For example, the widget can plot the locator ID on a map to display the geographical location that the user has been.

One scenario in which brand data can be captured is when a user is shopping at a store. A brand transmitter in the store transmits brand data to a user's capture device. The capture device receives the brand data and transfers the brand data and user ID to the management server through a computing device accessible to the user. Data may be transferred to the management server in the form of a uniform resource locator (URL) encoded with the brand data and user ID.

The examples and embodiments described herein below are related to the management of brand data for brand experience sites and third party sites including social networking sites. However, one skilled in the art would understand that the components, techniques and principles described herein with regard to brand data is also applicable to the management of other similar types of data and systems including online gaming data including massively multi-player online (MMO) data, social group data, membership data, institutional data, government data and similar data sources. For sake of clarity, the embodiments and examples are given in relation to the brand data, however, one skilled in the art would understand that the other types of data can also be managed using the same methods and structures.

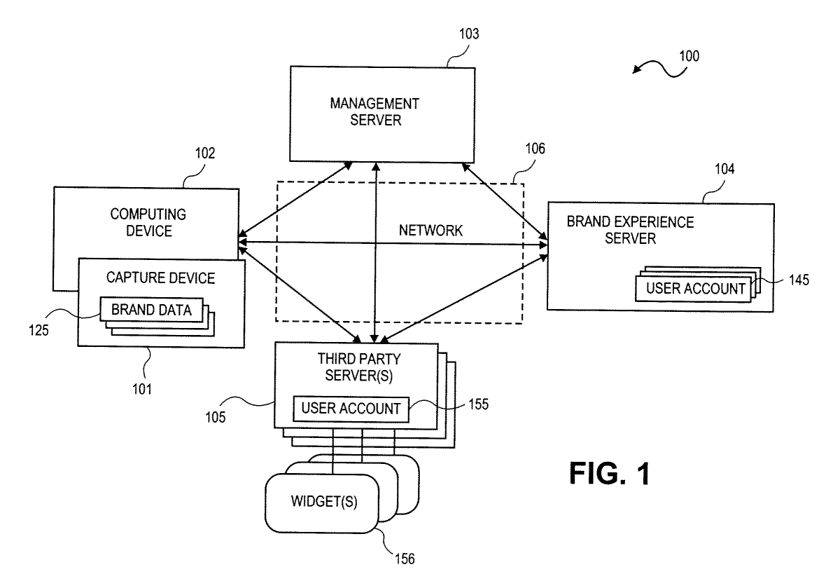

FIG. 1 is a diagram of one embodiment of a brand experience system 100. The brand experience system 100 includes a set of capture devices 101, a set of computing devices 102, a set of management servers 103, a set of brand experience servers 104 and a set of third party servers 105. A ‘set,’ as used herein, refers to any positive whole number of items. The diagram of FIG. 1 illustrates a single capture device 101 and computing device 102, a single management server 103 and a single brand experience server 104. However, one of ordinary skill in the art would understand that any number of the capture devices 101, computing devices 102, management servers 103 and brand experience servers 104 can be used in connection with the system.

The capture device 101 can be in any number of forms that are readily portable such as a keychain, wristwatch, accessory for a mobile phone or music player or similar form. Alternatively, the capture device 101 may be a mobile phone that uses a radio frequency (RF) or infra-red (IR) near field sensor to capture signals carrying the brand data, or a mobile phone that uses a built-in camera to capture a barcode or other visually encoded data to obtain the brand data. The capture device 101 may be active or passive. An active capture device detects and captures signals transmitted from a brand station when the capture device enters the vicinity of the brand station. A passive capture device captures brand station signals via a ‘quick-touch’ or ‘quick-click’ capture mechanism on the capture device that can be activated by a user's touching or clicking actions. The captured data is stored as brand data 125 in an internal data storage device of the capture device 101.

The captures devices 101 can be distributed to any number of users. Each user can use their capture devices 101 with their own computers or with any other computers. Any number of companies that offer loyalty programs or social networking services could offer their own set of capture devices 101 or could collaborate with one another to utilize the same set of capture devices 101. Each company may provide its own web server to interact with the capture devices 101, or a set of web servers for multiple companies may be administered by a third party.

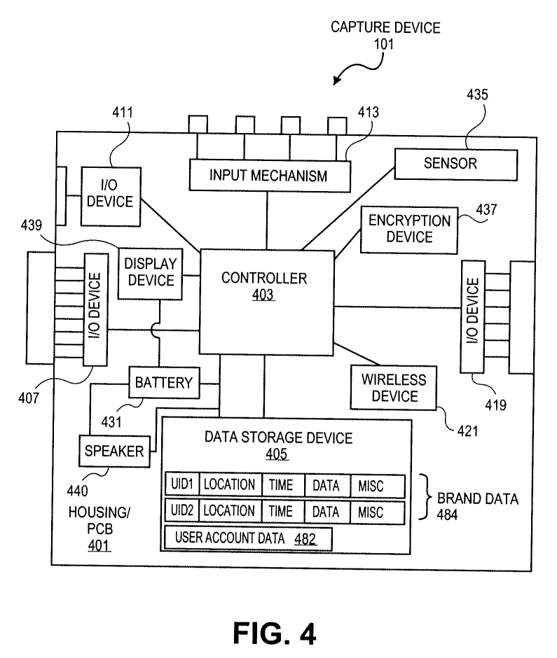

The capture device 101 includes a controller and internal data storage. The capture device 101 also includes a set of communication devices to enable communication with other capture devices, as well as computers, external sensors and transmitters, to receive, update and transfer the contents of the stored data. The capture device 101 can also include an input mechanism that allows the user to select a subset of the stored data to be transferred to or shared with other capture devices and computing devices. The capture device 101 will be described in greater detail in connection with FIG. 4.

The capture device 101 can be connected with the computing device 102 through a direct USB connection or similar physical communication mechanism, through a wireless communication protocol, or through a similar communication mechanism. In one embodiment, the capture device 101 and the computing device 102 can be physically connected and packaged as a single multi-functional portable device (e.g., a personal digital assistant or a mobile phone) that have data capture and web browsing capabilities.

The computing device 102 can be connected to any number of web servers, such as the management server 103, the brand experience server 104, and the third party servers 105, over a network 106. The network 106 can be any type of network including a public network (e.g., Internet), a private network (e.g., Ethernet, a Local Area Network (LAN), or a wide area network (WAN)), or similar networks. The network 106 can include any number of wired or wireless components.

The computing device 102 can be any type of computer device including a desktop computer, work station, laptop, console device, wireless device, handheld device, mobile phone or similar computing or multi-functional device capable of executing a general purpose application (e.g., a web browser) that can facilitate contact with the servers 103, 104 and 105 over the network 106. The computing device 102 can execute any number of applications and can rely on any type of operating system. A general purpose application such as a browser is utilized by the user of the capture device 101 to access and display his account information on the display of the computing device 102. The account information is maintained by the brand experience server 104 and the third party server 105 and is accessible by the user via the network 106.

In one embodiment, the management server 103 serves as an intermediary between the computing device 102 and the other web servers, such as brand experience server 104 and third party servers 105. The brand experience server 104 may operate a brand loyalty program for one or more companies. The third party servers 105 may be associated with one or more social networking sites. The management server 103 is authorized by theses companies and social networking sites to receive brand data and user ID from the user and to forward updates to the user accounts on these sites. The management server 103 also provides links and advertisements to the user of the capture device 101 based on the brand data. These links may be in the forms of URLs that point to a web page relating to the brand data.

The management server 103 receives the brand data and user ID from the computing device and looks up matching web services to which the data should be forwarded. The brand data and user ID may be embedded in a URL when received by the management server 103. The management server 103 maintains a lookup data structure, such as a table, that translates the locator ID and/or other information in the brand data into the links to the matching web services. For example, the locator ID can be correlated with a retailer. Using the locator ID, the management server 103 can determine a retailer or a store location of the retailer that provides the brand data. The management server 103 also maintains a list of advertisements from which one or more advertisements are selected to be provided to the user. The selection of the advertisements for the user may be random, or may be based on the matching web services, the date and time (if the advertisements are time sensitive), user information that was sent with the brand data, etc.

The management server 103 forwards the brand data and user ID to the web services as soon as the data is received or upon request. For example, the brand experience server 104 can receive the data as soon as the data is received and interpreted by the management server 103. The data can be sent to the brand experience server 104 in the form of a URL that encodes information of the brand data and user ID. Upon receipt of the data, the brand experience server 104 updates the point total and the available rewards for the user account. Some third party servers 105 may have contracted with the brand experience server 104 to receive the automatic update to the user account. Some other third party servers 105 may request the data when the user logs into the user account on the server and activates a widget embedded in the user's web page. The management server 103, in response to the request, sends the requested data to the widget on the third party servers 105 to update the widget data. In one scenario, the widget data can be used as user action data that is displayed in a map on the user's web page to track the user's actions.

The brand experience server 104 maintains user accounts 145 for tracking users' brand loyalty. The brand experience server 104 manages and provides content relating to a brand loyalty program. The brand experience server 104 interprets the received data and retrieves associated content or data stored in a database or similar data management structure. For example, the brand experience server 104 can decode received URLs and determine that the user has earned a new reward or new point total, which is then updated in the user account in the associated database. The brand experience server 104 also provides information or interactive features relating to a user account by displaying new points added to the account, rewards available to the account, and a map showing the nearest retail locations to the user where products of the brand can be purchased. A user of the capture device 101 may access his user account on the brand experience server 104 from a browser which displays the link provided by the management server 103.

The third party servers 105 maintain user accounts 155 and enable sharing of user data among the user's social networking circle. The shared user data includes all or a portion of the brand data captured by the user's captured device 101. The shared user data can be displayed on the user's web page or web blog and can be viewed by the user's friends. The user's web page or web blog can also display advertisements and links to the brand experience server 104, such that information relating to a brand can be shared among friends.

In one embodiment, the third party server 105 enables a user to share the brand data with his friends using plug-ins such as one or more widgets 156. The widget 156 is embedded in a person's web page and is provided by a software provider to supplement or expand the features of a social networking website, such as Facebook, web blogs, etc. For example, the widget 156 may use the locator IDs as widget data to display a map of the geographical locations of the retailers that a user has visited. Each third party server 105 may execute a different widget. Updates to the widget data can be sent from the management server 103, or alternatively, can be from the brand experience server 104. In one embodiment, the third party server 105 requests the management server 103 to send the updated widget data when a user logs into his account on the third party server. Alternatively, the management server 103 may send the updated widget data to the third party servers 105 as soon as it receives and interprets the brand data.

One of ordinary skill in the art would understand that the types of account data and features that can be managed by the servers 103, 104 and 105 can be any of those features or data points that are associated with these sites such as user point totals, user point account information, links with other accounts, reward totals, coupons, personal information, retailer locations visited by the user, product information, and other data relating to brand experience or social networking.

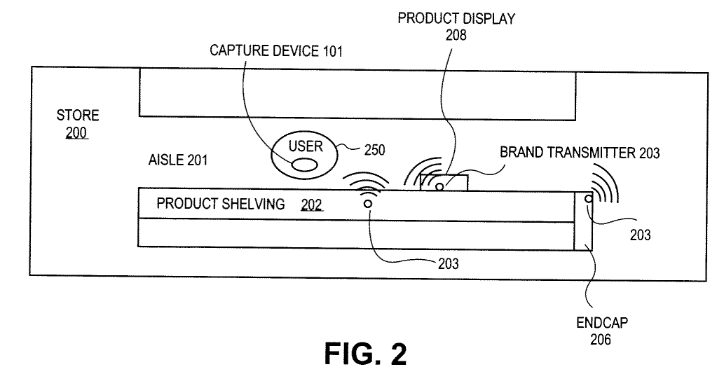

FIG. 2 illustrates one embodiment of an environment in which brand data can be captured. In FIG. 2, a store 200 layout is shown to have aisles (an aisle 201 is shown) between product shelves 202. Brand transmitters 203 are located on or attached to the product shelves 202. The brand transmitter 203 may be located in an endcap 206, in a standalone product display station 208, on a product, or other locations throughout the store 200. Only three brand transmitters 203 are shown for simplicity of the illustration; it is understood that any number of brand transmitters may exist in a store or on different sections of a shelf, with each transmitter providing data relating to one specific brand or a number of brands. The brand transmitter 203 transmits wireless signals continuously or upon detecting the presence the capture device 101 carried by a user 250. For example, the capture device 101 displays or is attached with an identifier such as a bar code, which, when scanned by the brand transmitter 203, triggers the transmitter 203 to transmit the wireless signal. The wireless signal is encoded with brand data, such as a locator ID that identifies the store location, the shelf, or the transmitter. The brand data may also include information of a product, the brand of the product, as well as current date and time.

The wireless signal may be captured by the capture device 101 using near field communication such as IR or RF communication. The capture device 101 may passively receive the wireless signal whenever the capture device 101 senses the presence of the wireless signal, or may actively receive the wireless signal only when the user 250 presses a button, a switch, or other mechanism to accept the transmission.

In one embodiment where the capture device 101 has a built-in scanner or camera (such as a mobile phone having a camera), the capture device 101 may capture the band data by taking an image of a visual identifier on the brand transmitter 203 that is encoded with locator ID and product data. In one embodiment, the capture device 101 may store the brand data only if the brand data is recognized by the capture device 101, for example, when the brand data is related to a company that distributes the capture device 101.

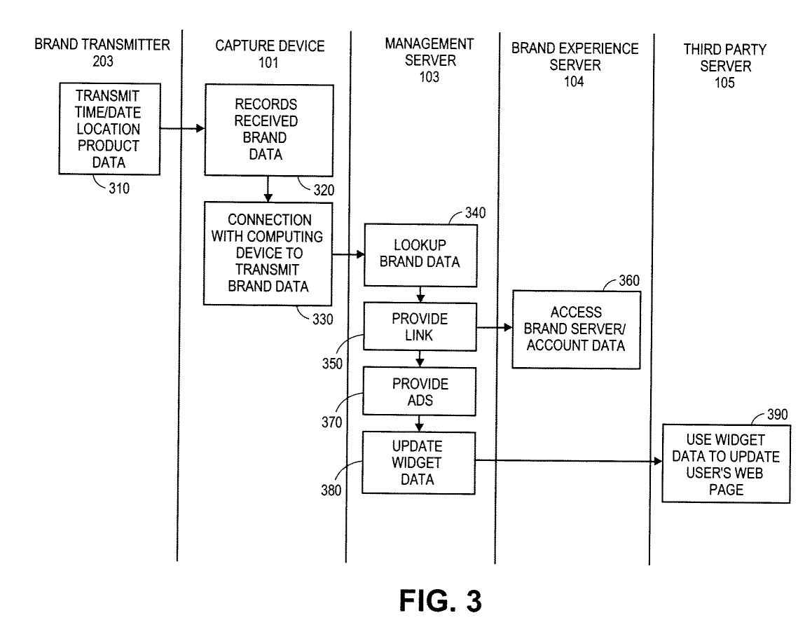

FIG. 3 is a diagram that illustrates one embodiment of a data exchange process among the brand transmitter 203, the capture device 101, the management server 103, the brand experience server 104 and the third party servers 105. The process begins when the brand transmitter 203 transmits brand data (e.g., time/date, location, product data, etc.) to the capture device 101 (block 310). As the brand data is captured, the capture device 101 records the received brand data in internal data storage (block 320). The capture device 101 establishes a connection with the computing device 102 to transmit the brand data to the management server 103 through the computing device 102 (block 330). The connection with the computing device 102 may be through a USB port, a wired connection or a wireless connection. In one embodiment, when a connection to the computing device 102 is detected, the capture device 101 executes an automatic execution file in its internal memory, which launches a browser on the computing device 102 and sends a link encoded with the brand data and user ID to the computing device 102. The link points to a web page hosted by the management server 103. The computing device 102 forwards the link with the encoded data to the management server 103, and loads the web page pointed to by the link into the browser for display to the user. In some embodiments, the brand data may be selectively transferred to the management server 103. For example, before the link with the encode data is sent to the management server 103, the computing device 102 may display a list of brand data entries on the screen and the user may select one or more of the brand data entries to be transferred to the management server 103. The capture device 101 may also include an input mechanism, such as buttons, switches, sliders, or dials, that can be used to select a unique identifier (UID) of a particular brand data entry to be transferred.

After receipt of transferred data, the management server 103 decodes or extracts the brand data and user ID from the received link. The management server 103 looks up the brand data (block 340) from a table or other similar data structure to determine the matching services for the user. The management server 103 provides the user with links to the matching web services (block 350), such as a URL to the brand experience server 104. The user can click on the link shown in the browser of the computing device 102 to access the user account provided by the web services, such as the brand loyalty program provided by the brand experience server 104 (block 360). The management server 103 also provides one or more advertisements relating to the web services to the user (block 370). The advertisements relating to the web services may be chosen from a list of advertisements randomly, or may be chosen based on the geographical location of the captured data, the date and time of the captured data (if the advertisements are time sensitive), or additional user information/preference that was sent from the capture device 101 with the brand data, etc.

The management server 103 also processes the data to be sent to the third party servers 105. Using the brand data and user ID, the management server 103 updates widget data (block 380) and sends the widget data to a third party server upon request from the third party server. Alternatively, the management server 103 may send the widget data to a third party server without receiving a request if the third party server has already established an agreement with the management server 103. A widget embedded in the user's web page on the third party server 105 then uses the widget data to update the user's web page (block 390).

FIG. 4 is a diagram of one embodiment of a capture device 101. In one embodiment, the capture device 101 is composed of a printed circuit board (PCB) 401 within a housing or similar substrate within a similar packaging. In other embodiments, any number of the components of the capture device 101 may be on separate substrates or not attached to substrates. The capture device 101 can have any shape or size. In one example embodiment, the capture device 101 has a form factor of a memory stick that is roughly rectangular with a length between one inch and three inches, a width between 0.1 inches and two inches and a depth between 0.1 inches and one inch. This form factor is provided by way of example and for the sake of clarity in describing an embodiment of the invention. Other example form factors are described below and one skilled in the art would understand that the principles and features of the described embodiments are applicable to other shapes, form factors and sizes.

The capture device 101 includes a controller 403. The controller 403 manages data I/O and the storage of data in data storage 405. The controller 403 can be an application specific integrated circuit (ASIC), a general purpose processor or a similar processor or controller. The controller 403 manages the movement of data between the other components of the capture device 101 and also drives the other components of the capture device 101. In one embodiment, the controller 403 incorporates some or all of the other components of the capture device 101. For example, the controller 403 can include a data storage device 405, an I/O device 407 or similar components.

The capture device 101 includes at least one storage device 405. The storage device 405 can be any type of persistent storage device. The persistent storage device 405 can be an electronically erasable programmable read only memory (EEPROM) storage device, a static random access memory (SRAM) device or similar persistent storage device. The storage device 405 can be any size and hold any amount of data depending on the type and characteristics of the storage device. In another embodiment, additional storage devices of any type or size can be included. The additional storage devices can be used to store different types of data, provide additional space, or facilitate a simpler design. For example, separate storage devices can be tied to separate input mechanisms, to be output by the capture device on selection of a corresponding input through an input mechanism 413.

The storage device 405 can store any type of content, links, digital assets, data structures or similar types of data. In one embodiment, the storage device 405 stores user account data 482 and a set of band data 484. The user account data 482 includes a user ID, which uniquely identifies a user account on the brand experience server 104 and third party servers 105. The user account data 482 may also include a user profile, such as an age group, hobbies, affiliations, other data that has been pre-programmed by the company distributing the capture device 101, or data that is entered by the user. The user account data 482 allows the management server 103 to transmit the brand data 484 to the correct user accounts on the brand experience server 104 and third party servers 105. The user account data 482 also allows the management server 103 to provide advertisements or other information appropriate for the user.

The brand data 484 includes a set of data entries. Each data entry is identified by a unique identifier (UID) and represents an instance of data captured by the capture device 101. For example, each data entry may include a location at which the data entry was captured, the time and date when the data entry was captured, information of a product, and other miscellaneous information. The brand data may 484 may be stored in HyperText Markup Language (HTML) or Extensible Markup Language (XML) format. The miscellaneous information in the brand data 484 may include media such as images, videos or audio files, or other content 113 including text documents, spreadsheet documents or other types of data. The storage device 405 maintains these data entries as part of a standard file system or file directory.

The capture device 101 may also include a battery 431. Any type of battery including an alkaline, lithium, ion, nickel cadmium, nickel metal hydride or similar type of battery can be utilized. The battery 431 provides power source for the capture device. In another embodiment the battery 431 can be replaced or assisted by other power sources such as external power sources, photovoltaic cells or similar power sources. The housing may be configured to allow easy replacement of the battery 431.

The capture device 101 can include any number of communication ports or input devices 407, 419 and 411. A first I/O device 407 can be any type of communication port, protocol or medium. The first I/O device 407 can be a universal serial bus (USB) port, fire wire port, serial port, parallel port or similar communications port. The first I/O device 407 can be connected to any type of physical connector or dongle. The connector can be male or female connector such as a male or female USB connector. In one embodiment, the second I/O device 419 can be the same type of communication port, controller, protocol or connector as the first I/O device 407. The second I/O device 419 can be a different type of controller including a proprietary type of connector. For example, the second I/O device 419 may control a specialized physical connector that communicates over a set of contact pads with other devices that have a complementary set of contact pads. In one example embodiment, these contact pads are oriented in a particular shape that requires the complementary pads to be properly aligned. For example, the shape of the contacts pads can be Y-shaped such that another capture device or computing device that communicates through the specialized communication system must align its contact pads having complementary Y-shape to create a communication link between the two capture devices

A third I/O device 411 can provide an alternative communication medium, connector type or protocol from the first I/O device 407 and the second I/O device 419. For example, the first and second I/O devices 419 and 407 may primarily utilize physical connections. The third I/O device 411 can be a wireless connection mechanism such as infra-red (IR) or a physical connection type dedicated to a specific device such as a handheld device, cellular communication device or similar device. The third I/O device 411 can be any type of communication port, connector, or communication protocol.

In one embodiment, any of the I/O devices 407, 419 and 411 of the capture device 101 can be implemented as a wireless device 421. The wireless device 421 can be any type of wireless device including a Bluetooth, 802.11 b/g/n, IR or similar type of wireless communication device. All of the I/O devices can be utilized to transfer and receive data from other electronic devices including other capture devices, personal computers, console devices, handheld gaming devices, cellular communication devices and similar electronic devices.

In one embodiment, the capture device includes an input mechanism 413. The input mechanism 413 can be any type of physical input mechanism connected to the electrical components of the capture device to generate electrical signals to be input into the controller 403 or other components of the capture device. The input mechanism 413 can be a set of switches, sliders, buttons, dials, touch pads or similar input mechanisms. These input mechanisms can be used individually or in combination to generate input signals that are processed by the controller 403. The input signals can be processed to select specific data entry in the storage device 405.

The capture device 101 can include a sensor 435. The sensor 435 can be any type of detection or sensing device. The sensor 435 can be used to detect any non-digital input such as an electromagnetic, kinetic, energy, light, mechanical or similar force. The sensor 435 can be a resistor, conductive ink, voltmeter, ammeter, ohmmeter, thermometer, photo detector or similar sensor. The sensor 435 can sample or similarly receive the non-digital input to generate an analog value or digital value representing the non-digital input. The sensor 435 can include an analog to digital (A/D) converter or an analog signal may be passed to the controller 403 or separate analog or digital converter. The controller 403 that converts or receives a digital representation of the non-digital input. This non-digital input can be used to modify existing data or can be stored as new data.

The capture device 101 can include an encryption device 437. The encryption device 437 provides security to the capture device by encrypting and decrypting data transmitted to or from the capture device 101 or within the capture device 101. In another embodiment, the encryption device 437 is a subcomponent of the controller 403. The encryption device 437 also facilitates the management of any protected data managed by the controller 403. The encryption device 437 and the controller 403 can confirm the transfer or deletion of data stored in the data storage device 405. This functionality can be utilized to prevent misuse of the capture device to dupe the social networking site or loyalty program site. For example, a malicious may user attempt to obtain more points or rewards than they are entitled to by preventing the clearing of new reward or loyalty point program information from the data storage device.

In one embodiment, the capture device 101 can include a display device 439. The display device 439 can be any type of display device including a cathode ray tube (CRT), liquid crystal display (LCD), light emitting diode (LED) or similar display type. The display device 439 can include a graphics controller or the controller 403 can drive the display device 439. The capture device 101 can include any number or size of display devices 439. The display device 439 can provide any resolution and color range including black and white or gray scaled graphics.

In one embodiment, the capture device 101 can include a speaker 440. The speaker 440 can be any type of speaker, such as an electro-acoustic transducer, which converts electrical signals into audible sounds. The speaker 440 receives signals from the controller 403 and converts the signals into sounds to be heard by the user. For example, the speaker may produce a beeping sound when brand data is successfully acquired by the capture device 101.

In one embodiment, the brand experience system including the management server, the brand experience server, the third party servers, the computing device and the capture device and their components are implemented as hardware systems and devices. In another embodiment, some of the components in the brand experience system are implemented as software (e.g., microcode, assembly language or higher level languages) stored on a machine-readable medium. A “machine readable” medium may include a computer readable storage medium and any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a locator ID and a user ID from a remote capture device through a separate computing device;
looking up matching services using the locator ID and the user ID; and
forwarding the locator ID and the user ID to the matching services.

2. The method of claim 1, further comprising:
looking up an advertisement based on the matching services; and
sending the advertisement to the computing device.

3. The method of claim 1, further comprising:
looking up a link to the matching services; and
sending the link to the computing device.

4. The method of claim 1, further comprising:
sending the locator ID to a widget for execution by a third party server, the widget to display user action data.

5. The method of claim 1, further comprising:
receiving time, date and product data with the locator ID.

6. The method of claim 1, further comprising:
updating a user account with the locator ID.

7. The method of claim 1, further comprising:
correlating the locator ID with a retailer.

8. The method of claim 1, further comprising:
mapping the locator ID to a geographical location; and
displaying the geographical location.

9. A system comprising:
a capture device coupled to a computing device; and
a management server to receive a locator ID and a user ID from the capture device and provide a link, advertisement, or widget update based on a lookup of the locator ID and user ID.

10. The system of claim 9, further comprising:
a transmitter device to transmit the locator ID to the capture device.

11. The system of claim 9 wherein the capture device also stores a location, date, time, and product ID.

12. A machine readable storage medium, having instructions stored therein, which when executed cause a computer to perform a set of operations comprising:
receiving a locator ID and a user ID from a remote capture device through a separate computing device;
looking up matching services using the locator ID and the user ID; and
forwarding the locator ID and the user ID to the matching services.

13. The machine readable storage medium of claim 12, having further instructions stored therein, which when executed cause a computer to perform a set of operations further comprising:
looking up an advertisement based on the matching services; and
sending the advertisement to the computing device.

14. The machine readable storage medium of claim 12, having further instructions stored therein, which when executed cause a computer to perform a set of operations further comprising:
looking up a link to the matching services; and
sending the link to the computing device.

15. The machine readable storage medium of claim 12, having further instructions stored therein, which when executed cause a computer to perform a set of operations further comprising:
sending the locator ID to a widget for execution by a third party server, the widget to display user action data.

16. The machine readable storage medium of claim 12, having further instructions stored therein, which when executed cause a computer to perform a set of operations further comprising:
receiving time, date and product data with the locator ID.

17. The machine readable storage medium of claim 12, having further instructions stored therein, which when executed cause a computer to perform a set of operations further comprising:
updating a user account with the locator ID.

18. The machine readable storage medium of claim 12, having further instructions stored therein, which when executed cause a computer to perform a set of operations further comprising:
correlating the locator ID with a retailer.

19. The machine readable storage medium of claim 12, having further instructions stored therein, which when executed cause a computer to perform a set of operations further comprising:
mapping the locator ID to a geographical location; and
displaying the geographical location.
